(19) United States
(12) Patent Application Publication
(10) Pub. No.: US 2021/0017757 A1
(43) Pub. Date: Jan. 21, 2021

(54) Three-Dimensional Foam Sealant

(71) Applicant: Galit Eizman, Brookline, MA (US)

(72) Inventor: Galit Eizman, Brookline, MA (US)

(21) Appl. No.: 17/061,661

(22) Filed: Oct. 2, 2020

Related U.S. Application Data
(63) Continuation-in-part of application No. 15/884,228, filed on Jan. 30, 2018, now Pat. No. 10,828,931.
(60) Provisional application No. 62/498,492, filed on Jan. 31, 2017.

(51) Int. Cl. E04B 1/68; E05F 5/06

(52) U.S. Cl. CPC E04B 1/6801; E05F 5/06

(57) ABSTRACT

The invention is a novel method of creating three-dimensional foam insulative objects formed by applying liquid nail polish or a solvent to polystyrene foam, thus softening the foam and allowing a person to mold the foam into a desired shape before it hardens. The products of the present invention have applications in venues including the insulation of buildings from temperature and from impacts. The use of a nail polish allows a user to create building materials with customizable shapes and colors.

### CROSS REFERENCE TO RELATED APPLICATIONS

This application is a continuation-in-part of U.S. Nonprovisional patent application Ser. No. 15/884,228 filed Jan. 30, 2018, which claims the benefit of U.S. Provisional Patent Application No. 62/498,492 filed Jan. 31, 2017, which are hereby incorporated by reference in their entirety.

### FIELD OF THE INVENTION

The present invention relates to a method of using a polymeric object for building sealant and/or molded impact absorbing materials for buildings

### BACKGROUND OF THE INVENTION

Buildings often have small air gaps that require filling to reduce the escape of conditioned air from a building. The present invention includes a method of using polystyrene foam to fill gaps in buildings and a method of using polystyrene foam to mold and produce impact bumpers in a building.

The method of using polystyrene foam to fill gaps in buildings includes providing a block of polystyrene foam, softening it using an ethyl- or butyl-acetate solution (hereinafter, the “solution”), molding the softened block of polystyrene foam to fit in a gap in a building (gap in a wall, window, etc.) and letting the ethyl- or butyl-acetate solution flash off or evaporate from the polystyrene foam, which hardens it.

The method of using polystyrene foam to mold and produce impact bumpers in a building includes providing a block of polystyrene foam, softening it using an ethyl- or butyl-acetate solution, molding the softened block of polystyrene foam into a desirable shape to provide an impact absorbing layer to an area of a building (such as a refrigerator door impacting a wall, a door knob impacting a wall, etc.) and letting the ethyl- or butyl-acetate solution flash off or evaporate from the polystyrene foam, which hardens it. Some methods of creating an impact bumper include the use of a “nail polish” to soften and color the polystyrene foam. “Nail polish” as used herein refers to a composition comprising polymeric binders, pigment, and solvent.

The methods disclosed herein provide low cost methods of sealing gaps in buildings and providing bumpers on building surfaces to prevent damage by swinging objects.

Molding gap sealing shapes and bumpers using a chemical and physical reaction is an unconventional method that requires neither sharp, complex, or expensive tools; nor highly-developed skills. In this case, the product is made by applying the solvent to polystyrene foam, causing the foam to dissolve, and molding the foam into a desired shape. In some embodiments, nail polish can be used to impart a pigment to the molded shape. After the solvent evaporates, the polystyrene foam turns into a solid and provides an isolative, insulative benefit or impact resistant benefit.

### BRIEF DESCRIPTION OF THE SEVERAL VIEWS OF THE DRAWINGS

FIG. 1 is a depiction of a method of softening a block of foam using a solvent and then applying the softened foam to a gap in a building alongside a window.

FIG. 2 is a depiction of a method of softening a block of foam using a solvent and then molding the softened block into an impact absorbing layer on a part of a building.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed terms. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, components, and/or groups thereof.

Unless otherwise stated, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention, and is not intended to limit the invention to the specific embodiments illustrated by the figures or description below.

The method of the present invention is made by a novel process that will now be described.

1. Provide a block of foam 10, preferably comprising polystyrene.

2. Pour a solvent 20 onto the block 10, wherein the solvent comprises an ethyl- or butyl-acetate solution.

3. Allow the solvent 20 to soften the block 10 into a malleable condition.

4. Identify a gap 30 within a building and apply the malleable foam block to the gap.

5. Allow the solvent to flash off or evaporate, causing the block to harden.

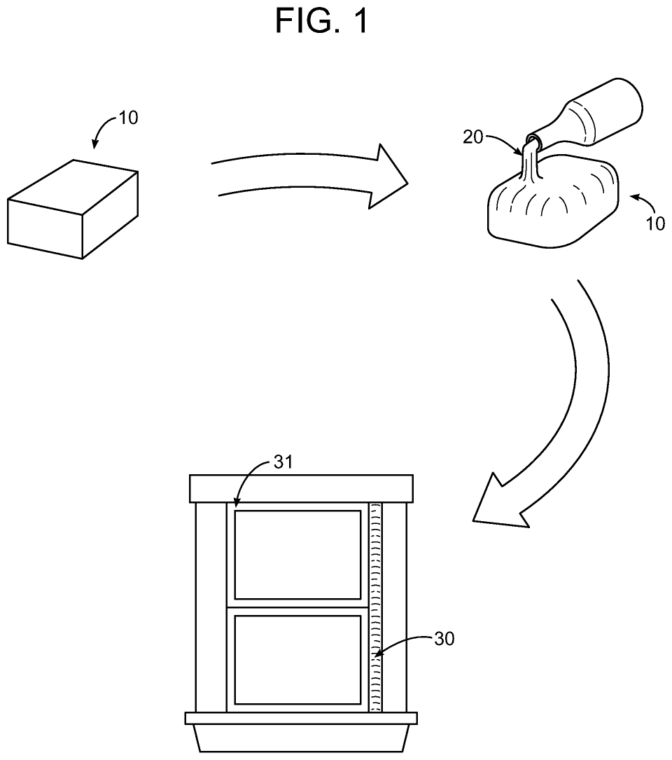

The aforementioned method is depicted in FIG. 1 where a block of foam 10 is softened where a solvent 20 is poured onto the foam 10. The softened foam is then applied to a gap 30 alongside a window 31 in a building. The gap along a window is an exemplary use and there are many more types of gaps that can arise in old or new buildings that could require the disclosed method.

The present invention also includes a method to provide an impact absorbing layer that will now be described.

1. Provide a block of foam 10, preferably comprising polystyrene.

2. Pour a solvent 20 onto the foam 10, wherein the solvent comprises an ethyl- or butyl-acetate solution.

3. Allow the solvent 20 to soften the block 10 into a malleable condition.

4. Identify a location within a building requiring an impact absorbing layer 40 and apply the malleable foam block into the appropriate shape and press it against the wall 48.

5. Allow the solvent to flash off or evaporate, causing the block to harden and become fixed to the wall 48, becoming an impact absorbing layer.

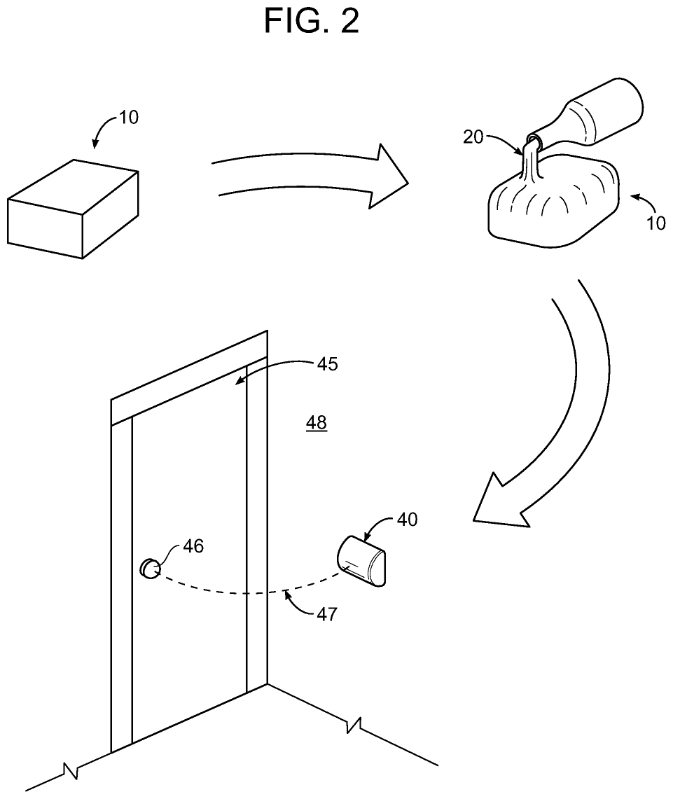

The aforementioned method is depicted in FIG. 2 where a block of foam 10 is softened where a solvent 20 is poured onto the foam 10. The softened foam is then molded into an impact absorbing layer 40 and applied to a wall 48 in a location within the path 47 of a doorknob 46. Once the foam 10 hardens, it will retain its shape and remain fixed to the wall 48. The impact absorbing layer 40 configured to prevent damage from a doorknob is an exemplary use and the method could be used to prevent damage from any swinging object (e.g., a refrigerator door, a cabinet door, etc.) or any high traffic area where a surface may be impacted. In some embodiments, the impact absorbing layer 40 comprises a rectangular base in the portion fixed to a wall 48.

In the methods to create an isolative, insulative layer and an impact absorbing layer, the solvent may be substituted or supplemented with nail polish to provide a desirable color to the foam 10 within a gap 30 or the impact absorbing layer 40. The use of nail polish can provide a gloss finish to the hardened foam 10, where the use of a solvent only can provide a more matte finish. As used herein, the term “insulative” includes isolating one area from another area. For example, insulating a gap would isolate one side of the gap from another side of the gap. Insulating or isolating do not require the method to create a thermal barrier in all situations. For example, the method of insulating or isolating could be used to create a barrier for bugs and insects and/or humidity.

Any of the myriad types and kinds of nail polish may be used, including gel, “cracked,” sparkled, shimmering, frosted and/or ordinary, matte-finish nail polish. The chemical composition of nail polish is made from nitrocellulose dissolved in butyl-acetate or ethyl-acetate. The nitrocellulose forms a shiny film as the acetate solvent evaporates. In addition, nail polish contains polymer resin, such a tosylamide/formaldehyde resin, that adds depth, gloss, and hardness to the film that remains after the acetate solvent evaporates. Camphor or other plasticizers are chemicals that help keep polish flexible and reduce the chance that it will crack or chip. They do this by linking to polymer chains and increasing the distance between them. Pigments are chemicals that add color to nail polish. Nail polish that has a shimmery or glittery effect may contain bits of plastic glitter or pearlescent minerals, such as titanium dioxide or ground mica. Nail polishes may contain thickening agents, such as stearalkonium hectorite. Some polishes contain ultraviolet filters, such as benzophenone-1, which help prevent discoloration when the polish is exposed to sunlight or other forms of ultraviolet light.

Polystyrene foam (commonly known as styrofoam) is the preferably material for the disclosed methods. Polystyrene foam, such as that used widely in commercial packaging, coffee cups and crafts materials (e.g., molds of heads, circular tubes), is a petroleum-based plastic made by stringing together, or polymerizing, styrene. In preferred embodiments, expanded polystyrene foam (EPF) is used. This material has special properties due to its structure of individual cells of low-density polystyrene.

Particularly effective solvents include acetone, butyl-acetate and ethyl-acetate, which can be used as the solvent in nail polish or nail polish remover. The solvent can be applied to the polystyrene object in a number of ways, including but not limited to, pouring the solvent or brushing the solvent onto the surface in a predetermined pattern.

The application of a solvent to polystyrene foam chemically melts or softens the polystyrene foam, allowing a person to mold an object out of the softened polystyrene foam. The concentration and volume of solvent applied to a polystyrene foam can be controlled to adjust the rate of reaction with the polystyrene foam.

The use of a solvent to melt or soften a volume of polystyrene foam can also be used in the aforementioned methods of to produce three-dimensional objects without the use of blades or cutters. A person can first apply a solvent to a volume of polystyrene foam to soften the volume into a malleable material. The malleable material can then be molded by a person into a desired shape and left to set. The malleable material sets when the solvent evaporates out of the material, leaving a hardened volume of polystyrene foam. The polystyrene foam can be used in locations where an insulative property is desired, including but not limited to insulation from temperature, electrical insulation and insulation from impacts. Household uses include using the malleable material to form custom bump guards within a dwelling to reduce the occurrence of damage from swinging items. For instance, a person could attach the malleable material to the edge of a counter within the door swing of a refrigerator. Once the malleable material sets on the edge of a counter, it would be able to prevent impact damage to both the counter and refrigerator.

A person skilled in the art will understand that invention according to this disclosure may be conducted with various changes without dividing from the ideas of this invention.

What is claimed is:

1. A method of insulating a gap within a building, comprising:
providing a block comprising polystyrene foam;
pouring a solvent onto the block, wherein the solvent comprises one of acetone, ethyl-acetate and butyl-acetate;
allowing the solvent to soften the block into a malleable condition;
identifying a gap within a building and applying the block to the gap while the block is in a malleable condition; and
allowing the solvent to evaporate, causing the block to harden.

2. The method of claim 1, further comprising the step of applying nail polish to the block.

3. The method of claim 1, wherein the solvent comprises a nail polish.

4. A method of insulating a surface within a building from impacts, comprising:
providing a block comprising polystyrene foam;
pouring a solvent onto the block, wherein the solvent comprises one of acetone, ethyl-acetate and butyl-acetate;
allowing the solvent to soften the block into a malleable condition;
identifying a surface within a building that requires an impact absorbing layer and applying the block to the surface while the foam is in a malleable condition; and
allowing the solvent to evaporate, causing the block to harden and remain fixed to the surface as an impact absorbing layer.

5. The method of claim 4, further comprising the step of applying nail polish to the block.

6. The method of claim 4, wherein the solvent comprises a nail polish.

7. The method of claim 4, wherein the impact absorbing layer comprises a rectangular base fixed to a wall.
